(19) United States
(12) Patent Application Publication
(10) Pub. No.: US 2019/0151910 A1
(43) Pub. Date: May 23, 2019

(54) RAPID REACTION HOOD SYSTEM

(71) Applicant: Jedson Engineering, Inc., Cincinnati, OH (US)

(72) Inventor: Robert J. Mayne, JR., Batavia, OH (US)

(73) Assignee: Jedson Engineering, Inc., Cincinnati, OH (US)

(21) Appl. No.: 16/196,952

(22) Filed: Nov. 20, 2018

Related U.S. Application Data
(60) Provisional application No. 62/588,653, filed on Nov. 20, 2017.

(51) Int. Cl. B08B 15/04; B08B 1/02; B65H 26/00

(52) U.S. Cl. CPC B08B 15/04; B08B 1/02; B65H 26/00; B65H 2407/10; B65H 2601/51; B65H 2553/40; B65H 2553/81; B65H 2601/261; B65H 2407/50

(57) ABSTRACT

A rapid reaction hood system includes at least one linear conveyor and a hood attached to the at least one conveyor and including a slot configured to collect dust emissions. The rapid reaction hood system also includes at least one proximity sensor positioned on the hood and configured to detect a distance from the hood to a roll of material. The conveyor is configured to move the hood linearly in response to a detection by the at least one proximity sensor.

### CROSS REFERENCE TO RELATED APPLICATION

This application claims the benefit of U.S. Provisional Application Ser. No. 62/588,653, filed on Nov. 20, 2017, the disclosure of which is incorporated by reference herein in its entirety.

### TECHNICAL FIELD

This application relates generally to manufacturing processes. More specifically, this application describes devices for capturing dust emissions generated during manufacturing processes.

### BACKGROUND

Many manufacturing processes include the processing (e.g., developing and/or unwinding) of rolls of material, which generates dust emissions. These dust emissions can negatively impact employee health, risk of fire or explosion, machine reliability, and/or product quality. Thus, capturing and removing dust emissions from the manufacturing environment is an important goal among manufacturers.

Typically, manufacturers place stationary area hoods outside the maximum diameter of the roll to be processed in order to capture the generated dust emissions. During processing of the roll of material, the prior art hoods are not always close enough to the dust generation source points to be effective in capturing dust emissions. In this regard, as the roll is developed or unwound, thereby expanding or contracting in diameter, the distances between the dust generation source points and the stationary hoods vary. Typical hoods have a slot velocity of 4,000 feet per minute, and thus only have an effective capture velocity up to 12 inches away from the slot hood face in conventional paper making applications. Increasing the slot velocity may not be a desirable solution because system static pressure requirements would necessarily increase, thereby causing higher fan motor horsepower requirements while also creating negative sheet handling issues.

As shown in FIGS. 1A and 1B, a conventional paper making system 10 may include a roll development rail 12 for supporting a core 14 about which a new parent roll 16 may be developed, and positioned proximate a reel drum 18 configured to advance a paper sheet 20 about the core 14. The parent roll 16 may be developed up to 130 inches in diameter. A stationary area hood 22 is typically located above the reel/parent roll development area, which can be 132 inches away from the source of dust emissions D as the roll 16 develops to a diameter of 130 inches.

Table 1 provides exemplary estimated parameters that may be typical for developing a premium grade toilet tissue product wherein the product width is 210 inches and the developing reel is operated at 5,000 fpm while using a conventional dust control approach such as that shown in FIGS. 1A and 1B.

TABLE 1
Conventional Dust Control Approach for
Paper Making at Reel Development

| | Total | Net Working | | | |
|---|---|---|---|---|---|
| | Exhaust | Exhaust | Grain | Dust | Dust |
| | Volume | Volume | Loading | Capture | Capture |
| Hood | (cfm) | (cfm) | (grains/ft³) | (lbs/min) | (lbs/hr) |
| Overhead | 25,000 | 25,000 | 0.03 | 0.107 | 6.42 |
| Hood | | | | | |
| Total | 25,000 | 25,000 | 0.03 | 0.107 | 6.42 |

As shown in FIGS. 2A and 2B, a conventional paper converting system 30 may include a roll support (not shown) for supporting a roll such as the roll 16 developed in FIGS. 1A and 1B and accompanying core 14, and a plurality of stationary hoods 32, 34, 36 typically placed on the floor and/or proximate an idler 38 outside the maximum diameter of the roll. For a roll 16 having a diameter of 130 inches, the stationary hoods 32, 34 can be 65 inches away from the source of dust emissions D as the roll 16 unwinds.

Table 2 provides exemplary estimated parameters that may be typical for unwinding/converting a premium grade 2-ply toilet tissue product wherein the product width is 101 inches and the converting line operation is at 3,000 fpm while using a conventional dust control approach, such as that shown in FIGS. 2A and 2B.

TABLE 2
Conventional Dust Control Approach for Parent Roll Unwinding

| | Total | | | | |
|---|---|---|---|---|---|
| | Exhaust | Net Working | Grain | | |
| | Volume | Exhaust | Loading | Dust | Dust |
| | w/Bleed | Volume | (grains/ | Capture | Capture |
| Hood | (cfm) | (cfm) | ft³) | (lbs/min) | (lbs/hr) |
| Floor Hood 1 | 4,000 | 3,600 | 0.03 | 0.015 | 0.90 |
| Floor Hood 2 | 4,000 | 3,600 | 0.03 | 0.015 | 0.90 |
| 1^{st} Idler Hood | 3,080 | 2,800 | 0.06 | 0.024 | 1.44 |
| Total | 11,080 | 10,000 | n/a | 0.054 | 3.24 |

Thus, it would be desirable to provide a device for providing improved capture of dust emissions generated during manufacturing processes.

### SUMMARY

In one embodiment, a rapid reaction hood system includes at least one linear conveyor and a hood attached to the at least one conveyor and including a slot configured to collect dust emissions. The rapid reaction hood system also includes at least one proximity sensor positioned on the hood and configured to detect a distance from the hood to a roll of material. The conveyor is configured to move the hood linearly in response to a detection by the at least one proximity sensor. The rapid reaction hood system may further include at least one track, wherein the at least one linear conveyor is enclosed within the at least one track. In addition or alternatively, the at least one linear conveyor may include first and second linear conveyors positioned proximate opposite ends of the hood. The at least one linear conveyor may include at least one of a ball screw linear conveyor or a belt conveyor. The hood may further include an exhaust port positioned on a same side of the hood as the slot.

The rapid reaction hood system may also include a flexible duct in communication with the slot. In one embodiment, the at least one proximity sensor is positioned on a same side of the hood as the slot. The at least one proximity sensor may include at least one of an optical sensor or an ultra-sonic sensor. The rapid reaction hood system may also include at least one linear servo motor operatively coupled to the at least one conveyor for affecting movement of the at least one conveyor. In one embodiment, the hood is constructed of aluminum.

In another embodiment, a paper making system includes the rapid reaction hood system. In yet another embodiment, a paper converting system includes the rapid reaction hood system.

In another embodiment, a method of collecting dust emissions includes positioning a hood having a slot for collecting dust emissions at a first distance from a source of dust emissions, the source having a variable size. The method also includes detecting a change in size of the source and, in response to detecting the change in size of the source, moving the hood linearly to maintain the hood at the first distance from the source. The source of dust emissions may be a roll of material, and the change in size of the source may be caused by the roll developing or unwinding. Detecting a change in size of the source may be performed via a proximity sensor positioned on the hood and configured to detect a distance from the hood to the source of dust emissions. In addition or alternatively, moving the hood linearly may be performed via at least one linear conveyor attached to the hood.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, serve to explain the one or more embodiments of the invention.

FIG. 1A is a schematic view of a paper making system including a stationary area hood, showing a new roll to be developed.

FIG. 1B is a schematic view similar to FIG. 1A, showing a parent roll developed.

FIG. 2A is a schematic view of a paper converting system including a stationary area hood, showing a parent roll to be unwound.

FIG. 2B is a schematic view similar to FIG. 2A, showing the parent roll unwinding complete.

FIG. 3A is a schematic view of a paper making system including an exemplary rapid reaction hood system with a dynamic hood thereof in a first position and showing a new roll to be developed, in accordance with an aspect of the invention.

FIG. 3B is a schematic view similar to FIG. 3A, showing the dynamic hood in a second position and showing a parent roll developed.

FIG. 4A is a schematic view of a paper converting system including an exemplary rapid reaction hood system with a dynamic hood thereof in a first position and showing a parent roll to be unwound, in accordance with another aspect of the invention.

FIG. 4B is a schematic view similar to FIG. 4A, showing the dynamic hood in a second position and showing the parent roll unwinding complete.

FIG. 5 is a perspective view of another exemplary rapid reaction hood system, in accordance with an aspect of the invention.

FIG. 6 is a top view of the rapid reaction hood system of FIG. 5, showing a controller operatively coupled to other components of the system.

### DETAILED DESCRIPTION

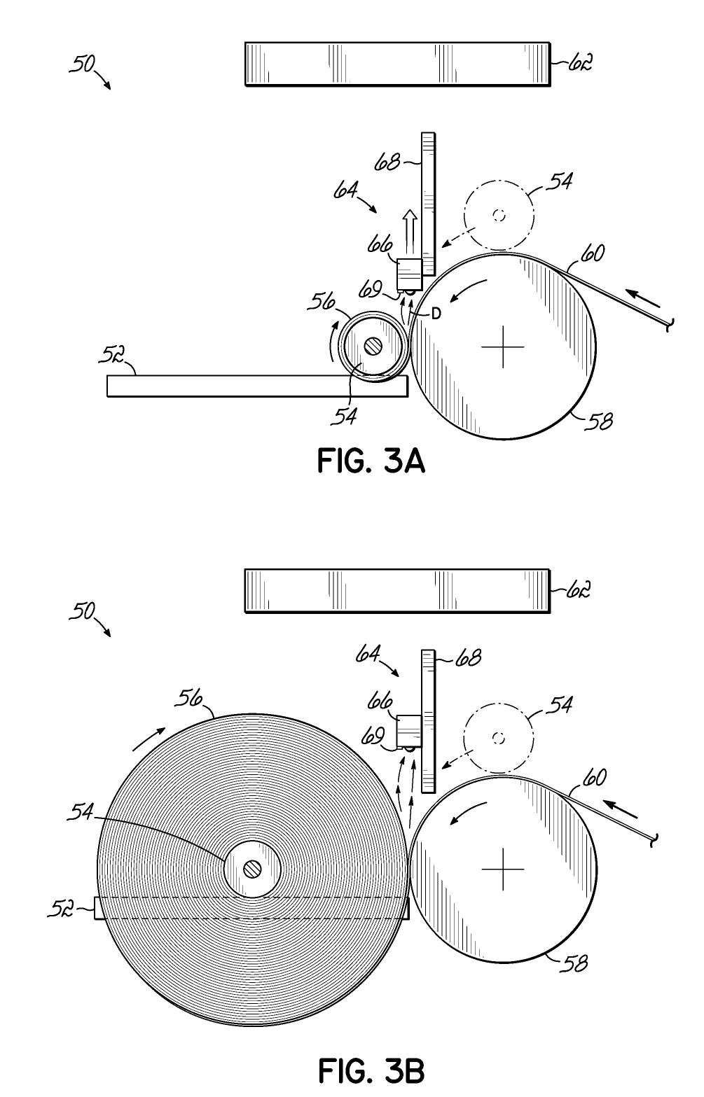

With reference to FIGS. 3A and 3B, a paper making system 50 includes a roll development rail 52 for supporting a core 54 about which a new parent roll 56 may be developed, and positioned proximate a reel drum 58 configured to advance a paper sheet 60 about the core 54. A stationary area hood 62 is located above the reel/parent roll development area. However, rather than relying solely on the stationary area hood 62 wherein the distance to the dust emission source point(s) varies as the roll 56 is developed, the paper making system 50 includes an exemplary rapid reaction hood system 64 including at least one dynamic hood 66 in accordance with an embodiment of the invention. The dynamic hood 66 is configured to move linearly in order to maintain a close proximity to the dust emission source point(s). In other words, the dynamic hood 66 may move in response to the expansion or contraction of the diameter of the roll 56 so as to track the position of the dust emission source point. For example, the dynamic hood 66 may be configured to be continuously within a 12 inch capture velocity zone as the roll 56 develops and/or unwinds. Thus, the dynamic hood 66 may continually move with the dust emission source points of the roll 56, and may also move out of the way for product handling demands. The features of the rapid reaction hood system 64 and dynamic hood 66 are set forth in further detail below to clarify each of these functional advantages and other benefits provided in this disclosure.

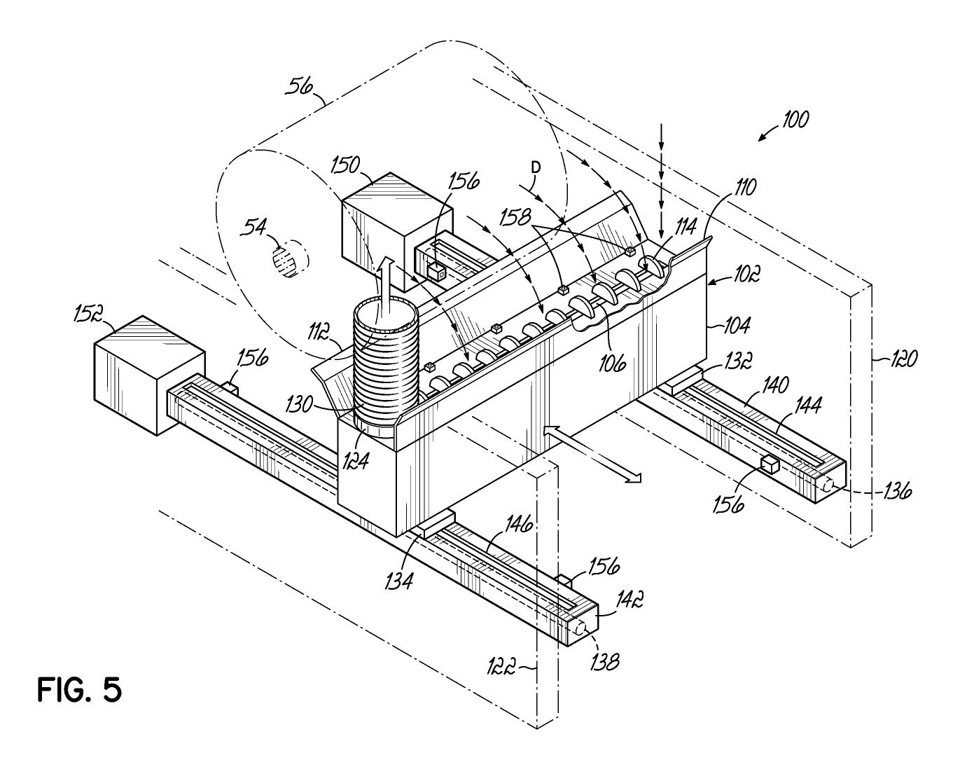

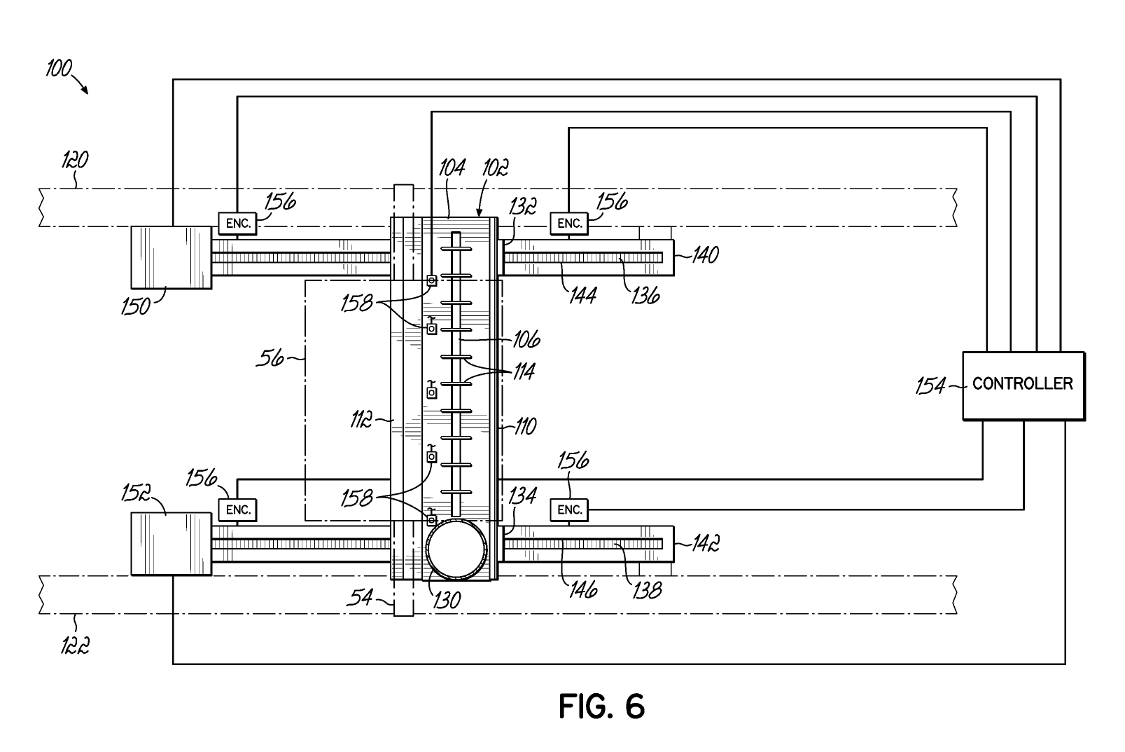

The illustrated dynamic hood 66 is attached to at least one conveyor enclosed in at least one elongate track 68, such that the hood 66 may travel along the at least one track 68 in a linear manner. The at least one track 68 may be positioned with one end proximate to the nip point between the reel drum 58 and the developing roll 56 and the other end distal from the nip point, and may be configured to avoid interfering with the roll 56 as it develops. The at least one track 68 may be stationary, such as by coupling the at least one track 68 to one or more sidewalls of a machine frame of the paper making system 50. The at least one conveyor may be actuated by at least one servo motor, for example, in order to affect linear movement of the dynamic hood 66 along the track 68. A proximity sensor 69 is positioned on a front end of the dynamic hood 66 facing the roll 56, such that the dynamic hood 66 may be configured to move along the track 68 in response to a detection of the roll 56 by the proximity sensor 69, as described in greater detail below. While the illustrated rapid reaction hood system 50 is shown schematically, further details are illustrated in FIGS. 5 and 6.

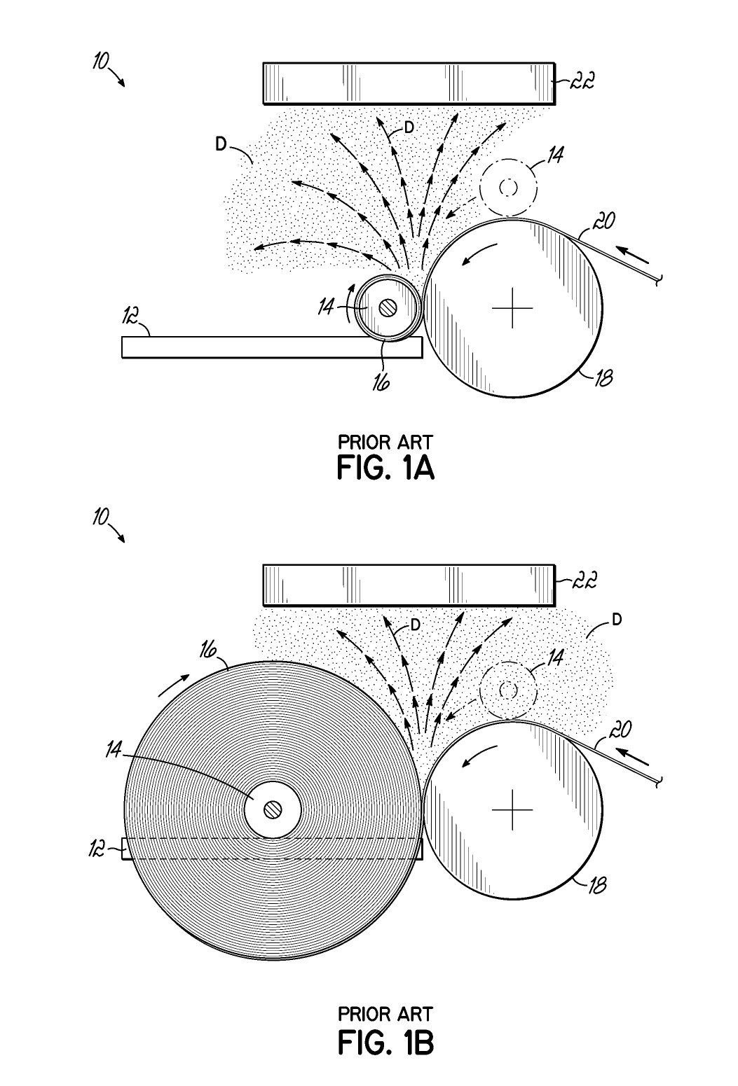

With continuing reference to FIGS. 3A and 3B, in an exemplary paper making application there is a significant amount of dust emissions ejected from the nip point between the reel drum 58 and the developing roll 56 (see, e.g., FIGS. 1A and 1B). By initially positioning the dynamic hood 66 proximal to the nip point, such as within 12 inches thereof, during the development of the roll 56, dust emission capture effectiveness at the nip point may be significantly increased as compared to prior art systems. As the roll 56 develops, the dynamic hood 66 may travel along the at least one track 68 via the at least one conveyor away from the nip point in order to avoid contacting the diametrically expanding roll 56, while remaining within the 12 inch capture velocity zone (FIG. 3B). In addition or alternatively, the dynamic hood 66 may travel along the at least one track 68 away from the roll development rail 52 in order to allow a new core 54 (shown in phantom) to be delivered to the roll development rail 52. In the embodiment shown, the typical stationary area hood 62 is also included for capturing dust emissions in the conventional manner. Alternatively, the stationary area hood 62 may be eliminated.

Table 3 provides exemplary estimated parameters that may be achieved for the same development process described with respect to Table 1 while using the dust control approach illustrated in FIGS. 3A and 3B.

TABLE 3
Dynamic Hood Dust Control Approach for
Paper Making at Reel Development

| | Total | Net Working | | | |
|---|---|---|---|---|---|
| | Exhaust | Exhaust | Grain | Dust | Dust |
| | Volume | Volume | Loading | Capture | Capture |
| Hood | (cfm) | (cfm) | (grains/ft³) | (lbs/min) | (lbs/hr) |
| Overhead | 13,450 | 13,450 | 0.03 | 0.058 | 3.48 |
| Hood | | | | | |
| Rapid | 11,550 | 10,500 | 0.11 | 0.165 | 9.90 |
| Reaction | | | | | |
| Hood | | | | | |
| Total | 25,000 | 23,950 | n/a | 0.223 | 13.38 |

As shown by comparing the parameters of Table 3 with those of Table 1, dust capture collection using the dynamic hood 66 may realize a 108% increase in dust collection using the same amount of air volume as the conventional approach.

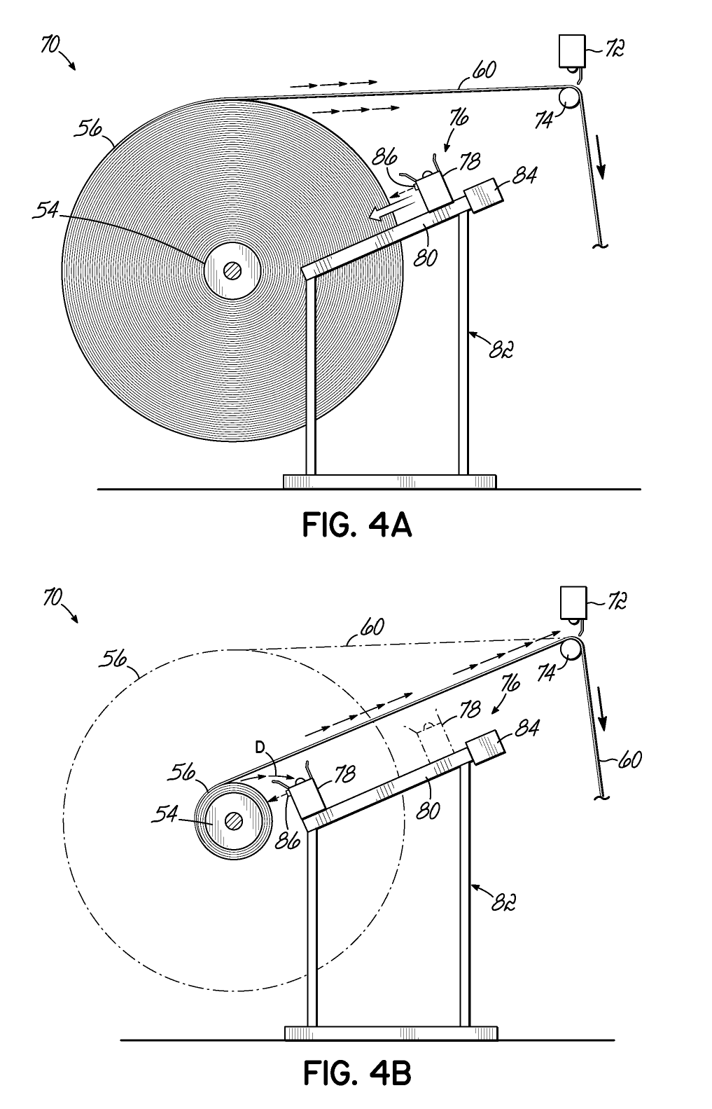

Referring now to FIGS. 4A and 4B, a paper converting system 70 includes a roll support (not shown) for supporting a roll such as the roll 56 developed in FIGS. 3A and 3B and accompanying core 54, and a stationary hood 72 placed proximate an idler 74. However, rather than relying solely on the stationary hood 72 wherein the distance to the dust emission source point(s) varies as the roll 56 is unwound, the paper converting system 70 includes an alternative exemplary rapid reaction hood system 76 including at least one dynamic hood 78 in accordance with another embodiment of the invention. The dynamic hood 78 may be generally similar to the dynamic hood 66.

The illustrated dynamic hood 78 is attached to at least one conveyor enclosed in at least one elongate track 80, such that the hood 78 may travel along the at least one track 80 in a linear manner. The at least one track 80 may be positioned with one end proximate to the core 54 of the roll 56 and the other end distal from the core 54, and may be configured to avoid interfering with the roll 56 as it unwinds. For example, the at least one track 80 may be positioned axially outwardly relative to the roll 56 and/or core 54. The at least one track 80 may be stationary, such as by coupling the at least one track 80 to one or more dedicated frames 82 for supporting the at least one track 80 from the floor. Alternatively, the at least one track 80 may be coupled to one or more sidewalls of a machine frame of the paper converting system 70. The at least one conveyor may be actuated by at least one servo motor 84, for example, in order to affect linear movement of the dynamic hood 78 along the track 80. A proximity sensor 86 is positioned on a front end of the dynamic hood 78 facing the roll 56, such that the dynamic hood 78 may be configured to move along the track 80 in response to a detection of the roll 56 by the proximity sensor 86, as described in greater detail below. While the illustrated rapid reaction hood system 76 is shown schematically, further details are illustrated in FIGS. 5 and 6.

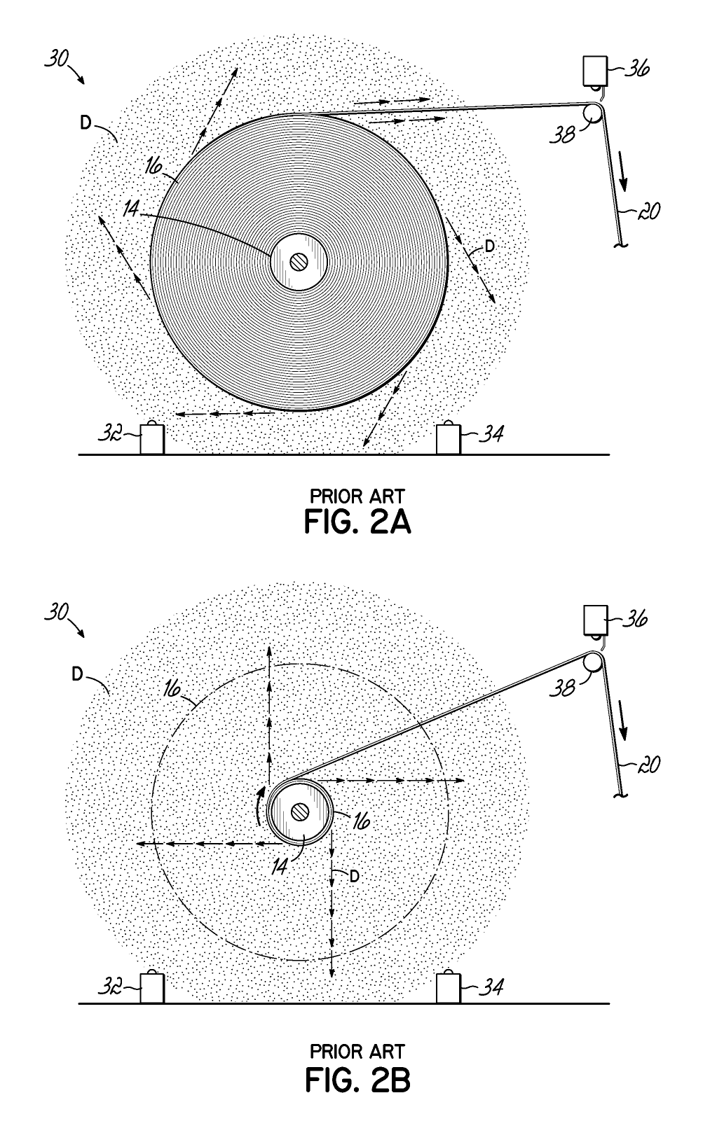

With continuing reference to FIGS. 4A and 4B, in an exemplary paper converting application dust emissions are ejected at the unfold crepe point and may rotate around the unwinding roll 56 due to the gravitational pull of the rotating roll (see, e.g., FIGS. 2A and 2B). By initially placing the dynamic hood 78 proximal to the unfold crepe point, such as within 12 inches thereof, and allowing the dynamic hood 78 to travel along the at least one track 80 to maintain close proximity to the unfold crepe point while the roll 56 diametrically contracts, dust emissions captured may be significantly increased, such as by 200%, as compared to prior art systems. In addition, or alternatively, the dynamic hood 78 may travel along the track 80, which may be outside the material handling envelope, away from the core 54 in order to allow the spent core 54 to be removed and/or to allow a new parent roll 56 to be loaded.

Table 4 provides exemplary estimated parameters that may be achieved for the same converting process described with respect to Table 2 while using the dust control approach illustrated in FIGS. 4A and 4B.

TABLE 4
Dynamic Hood Dust Control Approach for Parent Roll Unwinding

| | Total | | | | |
|---|---|---|---|---|---|
| | Exhaust | Net Working | | | |
| | Volume | Exhaust | Grain | Dust | Dust |
| | w/Bleed | Volume | Loading | Capture | Capture |
| Hood | (cfm) | (cfm) | (grains/ft³) | (lbs/min) | (lbs/hr) |
| Rapid | 3,080 | 2,800 | 0.11 | 0.044 | 2.64 |
| Reaction | | | | | |
| Hood | | | | | |
| 1^{st} Idler Hood | 3,080 | 2,800 | 0.06 | 0.024 | 1.44 |
| Total | 6,160 | 5,600 | n/a | 0.068 | 4.08 |

As shown by comparing the parameters of Table 4 with those of Table 2, dust capture collection using the dynamic hood 78 may realize a 26% increase in dust collection with a 44% decrease in dust control air volume. Thus, the dynamic hood 78 may allow for maximizing dust control effectiveness while minimizing air volume. As a result, the cost of offline capital filtration equipment may be driven down, and ongoing operational electrical power savings may be achieved.

Referring now to FIGS. 5 and 6, an exemplary rapid reaction hood system 100 is illustrated in greater detail and includes a dynamic hood 102. The illustrated dynamic hood 102 includes a hollow manifold or body 104 having a continuous slot 106 on the front intake side for capturing dust emissions. The body 104 may be constructed of aluminum to minimize weight of the hood 102 as it moves. In the embodiment shown, a pair of projections 110, 112 extend outwardly from the slotted front side of the hood 102 for guiding dust emissions therein. Hood slot protectors 114 are spaced apart across the slot 106 to prevent the ingestion of the product web, such as in the event of a web break. In one embodiment, the body 104 may taper with a smaller width proximate the tending-side wall 120 of a machine frame of the paper making or converting system and a larger width proximate the drive-side wall 122. Such a configuration may assist in accommodating an exhaust port 124 on the body 104 proximate the drive-side wall 122. The slot 106 may be tapered in the opposite direction, e.g., with a larger width proximate the tending-side wall 120 and a smaller width proximate the drive-side wall 122, to allow an even slot velocity profile across the length of the hood 102. In one embodiment, the slot 106 may have a minimum width of approximately ⅝ inch proximate the drive-side wall 122. The dust control airflow of the hood 102 may be configured for a minimum of approximately 27 feet per minute (fpm) per inch of slot length. The hood slot length may overlap the web width by approximately 1 inch each side proximate the tending-side wall 120 and the drive-side wall 122. In one embodiment, a 10% air bleed may be provided proximate the tending-side wall 120 to accelerate air for even hood manifold velocity profile within the hood 102. In addition or alternatively, the hood slot velocity may be no less than approximately 4,000 fpm. The hood manifold velocity may have a transport velocity range of approximately 3,500 fpm to approximately 4,000 fpm. The approximate static pressure requirement may be approximately −4 inch water gauge (w.g.) to assist in getting dusty airflow from outside the hood 102 to the exhaust port 124.

A flexible hose or duct 130 for dust control exhaust is coupled to the exhaust port 124 of the dynamic hood 102 to avoid restraining movement of the dynamic hood 102. In this regard, the flexible duct 130 may be extendible, contractible, and self-supporting while having high flexibility. For example, the flexible duct 130 may be constructed of a material such as polypropylene with service of working pressure of approximately 2 psi at approximately 68° F. and vacuum rating of approximately −3 inch-Hg at approximately 68° F. In one embodiment, the flexible duct 130 may include a wire, such as a steel helical wire, for grounding. In the embodiment shown, the exhaust port 124 is positioned on the front intake side of the hood 102 to assist in directing the flexible duct 130 along and/or over the drive-side wall 122. However, any other suitable configuration may be used.

As shown, a pair of connection plates or linear bearing blocks 132, 134, which may be constructed of aluminum and welded to the bottom of the hood manifold 104, attach the hood 102 to a pair of linear conveyors or actuators in the form of ball screw linear conveyors 136, 138 enclosed in respective elongate tracks 140, 142 via slots 144, 146, such that the hood 102 may travel along the tracks 140, 142 in a linear manner. The conveyors 136, 138 may alternatively be any conveyors suitable for moving the hood 102 along the tracks 140, 142, such as enclosed belt conveyors, for example. In any event, the tracks 140, 142 may each be positioned with one end proximate to the core 54 and the other end distal from the core 54, and may be configured to avoid interfering with the roll 56 as it changes in size. For example, the tracks 140, 142 may be positioned axially outwardly relative to the core 54 on opposite sides thereof. The tracks 140, 142 may be stationary, such as by coupling the tracks 140, 142 to the driving-side and tending-side walls 120, 122. In the embodiment shown, the tracks 140, 142 are each coupled to internal surfaces of the respective driving-side and tending-side walls 120, 122. In one embodiment, the conveyors may each be a linear actuator similar to that sold under the trademark Nook ELVZ 100.

In the embodiment shown, synchronized linear servo motors 150, 152 are operatively coupled to the linear conveyors 136, 138 for actuating the conveyors 136, 138 to drive linear movement of the dynamic hood 102 along the tracks 140, 142. In one embodiment, the servo motors 150, 152 may be low inertia servo motors similar to that sold under the trademark Kinetix VP. The linear servo motors 150, 152 are in operative communication with a controller 154, such as the owner's line programmable logic controller (PLC). The rapid hood reaction system 100 may also include one or more encoders 156. Together, the controller 154, servo motors 150, 152, encoders 156, and distance measuring devices or proximity sensors 158 may power and control the conveyors 136, 138 and thus movement of the hood 102 along the tracks 140, 142. This may allow the rapid reaction hood system 100 to locate a hood home position, find a roll high point set point, and maintain this set point as the roll 56 grows or reduces in diameter to maximize dust capture effectiveness. In this manner, the rapid reaction hood system 100 may be configured to automatically move the dynamic hood 102 linearly along the tracks 140, 142 in response to the expansion or contraction of the roll 56 being processed in order to maintain the dynamic hood 102 in close proximity with the dust emission source point(s). In one embodiment, the electronics and controls package of the system 100 may be provided as a stand-alone self-contained system, such as a plug and play system, with communications to the owner's PLC or controller 154.

In one embodiment, the proximity sensors 158 may include optical sensors positioned on the dynamic hood 102 for identifying the distance to the diametrically expanding or contracting roll 56. For example, the sensors 158 may be positioned on the front intake side of the hood 102 or at any other suitable position facing the roll 56 and/or core 54 for identifying the distance to the roll 56 from the hood 102. The sensors 158 may communicate this data to the controller 154, which may send a movement command to the servo drives 150, 152 in response thereto in order to actuate the conveyors 136, 138 and move the dynamic hood 102. The position sensors 158 may be any other suitable sensor for identifying the distance to the roll 56, such as ultra-sonic sensors. In another embodiment, the dynamic hood 102 may be configured to travel at a predetermined rate(s) based on a predetermined rate(s) of expansion or contraction of the diameter of the roll 56.

The sequence of operations for dust control collection during a converting process using the rapid reaction hood system 100 will now be described. Initially, the hood 102 may be positioned in a home position (see, e.g., FIG. 4A) to allow placement of the parent roll 56 on the line via an over-head crane, for example. After the parent roll 56 is threaded and spliced on the line, and as the parent roll 56 begins to rotate, the controller 154 may command the conveyors 136, 138 to fast index the hood 102 to approximately 12 inches from the high point wobble of the roll 56 in response to the detection of the roll 56 by the position sensors 158. The controller 154 may then command the conveyors 136, 138 to slow advance the hood 102 to within a predetermined distance from the high point wobble estimated at approximately 1 inch away from the parent roll 56 near the uncrepe point. As the parent roll 56 unwinds, the position sensors 158 may communicate with the controller 154 which may, in turn, communicate with the servo motors 150, 152 to maintain or track the hood 102 approximately 1 inch away from the surface of the parent roll 56 (and/or of the high point wobble) so that the hood 102 may effectively collect the dusty air near the uncrepe point as the roll 56 unwinds (see, e.g., FIG. 4B). As the parent roll 56 approaches a state of complete unwinding, the PLC or controller 154 may receive a signal indicative of such and communicate with the servo motors 150, 152 to slow return the hood 102 toward the home position to allow the spent core 54 to be removed via the crane. The cycle may be then be repeated for a subsequent parent roll 56.

While the exemplary rapid hood reaction hood systems 64, 76, 100 and associated dynamic hoods 66, 78, 102 have been shown and described in varying detail and with varying features, the disclosed features may be used in any suitable combination. Moreover, while the rapid reaction hood system 64, 76, 100 has been described for use in a paper making or paper converting system, the rapid reaction hood system 64, 76, 100 may be used in any application for controlling dust emissions. In one embodiment, the rapid reaction hood system 64, 76, 100 may be retrofitted to a preexisting manufacturing system, such as a preexisting paper making or paper converting system.

While the present invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A rapid reaction hood system comprising:
at least one linear conveyor;
a hood attached to the at least one conveyor and including a slot configured to collect dust emissions; and
at least one proximity sensor positioned on the hood and configured to detect a distance from the hood to a roll of material, wherein the conveyor is configured to move the hood linearly in response to a detection by the at least one proximity sensor.

2. The rapid reaction hood system of claim 1, further comprising:
at least one track, wherein the at least one linear conveyor is enclosed within the at least one track.

3. The rapid reaction hood system of claim 1, wherein the at least one linear conveyor includes first and second linear conveyors positioned proximate opposite ends of the hood.

4. The rapid reaction hood system of claim 1, wherein the at least one linear conveyor includes at least one of a ball screw linear conveyor or a belt conveyor.

5. The rapid reaction hood system of claim 1, wherein the hood further includes an exhaust port positioned on a same side of the hood as the slot.

6. The rapid reaction hood system of claim 1, further comprising:
a flexible duct in communication with the slot.

7. The rapid reaction hood system of claim 1, wherein the at least one proximity sensor is positioned on a same side of the hood as the slot.

8. The rapid reaction hood system of claim 1, wherein the at least one proximity sensor includes at least one of an optical sensor or an ultra-sonic sensor.

9. The rapid reaction hood system of claim 1, further comprising:
at least one linear servo motor operatively coupled to the at least one conveyor for affecting movement of the at least one conveyor.

10. The rapid reaction hood system of claim 1, wherein the hood is constructed of aluminum.

11. A paper making system comprising the rapid reaction hood system of claim 1.

12. A paper converting system comprising the rapid reaction hood system of claim 1.

13. A method of collecting dust emissions, comprising:
positioning a hood having a slot for collecting dust emissions at a first distance from a source of dust emissions, the source having a variable size;
detecting a change in size of the source; and
in response to detecting the change in size of the source, moving the hood linearly to maintain the hood at the first distance from the source.

14. The method of claim 13, wherein the source of dust emissions is a roll of material, and wherein the change in size of the source is caused by the roll developing or unwinding.

15. The method of claim 13, wherein detecting a change in size of the source is performed via a proximity sensor positioned on the hood and configured to detect a distance from the hood to the source of dust emissions.

16. The method of claim 13, wherein moving the hood linearly is performed via at least one linear conveyor attached to the hood.

17. The method of claim 16, wherein detecting a change in size of the source is performed via a proximity sensor positioned on the hood and configured to detect a distance from the hood to the source of dust emissions.

18. The method of claim 17, wherein the source of dust emissions is a roll of material, and wherein the change in size of the source is caused by the roll developing or unwinding.

19. A rapid reaction hood system comprising:
first and second tracks,
first and second linear conveyors enclosed within the first and second tracks, respectively, wherein the first and second linear conveyors each include at least one of a ball screw linear conveyor or a belt conveyor;
a hood attached to the first and second conveyors such that the first and second conveyors are positioned proximate opposite ends of the hood, the hood including a slot configured to collect dust emissions and an exhaust port positioned on a same side of the hood as the slot;
a flexible duct in communication with the slot; and
at least one proximity sensor positioned on the hood on a same side of the hood as the slot and configured to detect a distance from the hood to a roll of material, wherein the at least one proximity sensor includes at least one of an optical sensor or an ultra-sonic sensor; and
first and second synchronized linear servo motors operatively coupled to the first and second conveyors for affecting movement of the first and second conveyors, respectively, wherein the first and second conveyors are configured to move the hood linearly in response to a detection by the at least one proximity sensor.

20. The rapid reaction hood system of claim 19, wherein the hood is constructed of aluminum.
